(19) United States
(12) Patent Application Publication
(10) Pub. No.: US 2017/0038000 A1
(43) Pub. Date: Feb. 9, 2017

(54) DEVICE FOR FASTENING A WEAR SENSOR TO A BRAKE LEVER OF A VEHICLE BRAKE

(71) Applicant: MAN Truck & Bus AG, München (DE)

(72) Inventors: Ludwig Füchsle, Jetzendorf (DE); Matthias Butz, München (DE); Thomas Wittmann, Gersthofen (DE)

(21) Appl. No.: 15/230,106

(22) Filed: Aug. 5, 2016

(30) Foreign Application Priority Data
Aug. 6, 2015 (DE) DE102015010348.2

(51) Int. Cl. F16M 13/02; F16D 65/40; F16D 66/02; B60T 17/22

(52) U.S. Cl. CPC F16M 13/02; B60T 17/22; F16D 65/40; F16D 66/021

(57) ABSTRACT

A device for fastening a wear sensor to a brake lever of a vehicle brake, in particular to a brake lever having an integrated adjustment function for the vehicle brake. The device having an integrated adjustment function of a vehicle brake has a recess for the contactless passage of a brake shaft; a first fastening point for fastening a first side of the device to a housing portion of the brake lever; and at least one second fastening point for fastening a wear sensor to a second side of the device opposite the first side, wherein the second fastening point is arranged spaced apart from the first fastening point.

### BACKGROUND

The invention relates to a device for fastening a wear sensor to a brake lever of a vehicle brake, in particular to a brake lever having an integrated adjustment function for the vehicle brake.

In the case of heavy commercial vehicles, use is made in a wide variety of use areas and types of vehicles of drum brakes which are affected by wear. According to the prior art, drum brakes are installed in heavy commercial vehicles, for example in the form of S-cam brakes of simplex design. Here, a pneumatic cylinder actuates a shaft with an S-cam via a brake lever having an integrated adjustment function. As a consequence, said S-cam presses the brake shoes, which are mounted rotatably on one side, against the brake drum and thus produces the desired braking action. Brake levers of this type are also called slack adjusters. Both terms should be regarded as identical in meaning within the context of the present invention.

As the wear increases, the brake lever here adjusts the initial position of the brake camshaft, and therefore, at the beginning of each braking operation, there is the same play between brake shoes and brake drum. Brake levers of this type are disclosed, for example, in DE 40 17 950 A1 or DE 20 2011 106 746 U1.

In order to be able to determine the state of wear of the brake linings continuously here, use is made of sensors which detect the adjustment which has already taken place. The state of wear of the brake linings can then be directly derived from the extent of the adjustment which has already taken place. The term “wear sensor” or else simply “sensor” is therefore also used below for a sensor of this type.

As is known from U.S. Pat. No. 5,207,299 A1 for example, said sensors can be integrated here in the brake lever or slack adjuster and can determine the adjustment which has already taken place from the positions of the integrated components. However, integrated sensors have the disadvantage that, in the event of an electrical defect of the sensor, the entire slack adjuster may have to be replaced. In addition, sensors of this type also cannot be retrofitted as desired in vehicles since here in turn again the entire slack adjuster would also then have to be renewed. This causes increased costs.

Furthermore, Patent EP 830 521 B1 discloses a device for displaying brake lining wear, which device can be attached retrospectively to the slack adjuster and which determines a relative change in the camshaft position with respect to the slack adjuster. For this purpose, a toothed plate engages in the toothing of the camshaft and is secured axially via a securing ring. A housing mounted rotatably there around contains the sensor system and is secured against rotation on the slack adjuster housing merely by means of a pin. During each adjustment, the toothed plate rotates by a certain angle in relation to the fixed housing. This angle is detected and recalculated into a wear volume.

The sensors which are known from the prior art and can be fitted retrospectively have the disadvantage that they can generally be fitted to the slack adjuster only in one manner, i.e. at a certain point in a certain orientation, corresponding to the designated fastening point on the slack adjuster. Due to this limitation, the situation may therefore arise that the sensors cannot be used for construction space reasons. However, because of the particular installation situation from case to case and the frequently small piece numbers, it may also not be expedient to produce a respectively adapted version of the sensor housing since this leads to increased costs in development. Wear sensing is then not possible for every application.

Laid-open application DE 10 2004 046 230 A1 furthermore discloses a device for detecting at least one state of wear of a vehicle brake which is actuable by rotation of a brake shaft having an automatic slack adjuster, comprising a ring arranged on the brake shaft for rotation therewith and a housing which surrounds the ring and is connected to the slack adjuster for rotation therewith. In order to be able to fasten this retrospectively fittable wear sensor in more than just one position on the brake shaft, it is proposed that the ring is composed of an inner adapter ring, which is in engagement with the brake shaft, and an outer ring, wherein outer ring and adapter ring are non-rotatable with respect to each other. In this manner, the device can be fastened in different positions on the brake shaft by exchange of the inner adapter ring. Differences in the brake shaft diameter or in the form thereof are compensated for by exchanging the adapter ring, and therefore the device can be fitted in different axial positions on the brake shaft. If, however, the wear sensor is intended to be fitted at a certain axial position, the situation may occur even in the case of this wear sensor that the sensor cannot be used for construction space reasons. Furthermore, the approach proposed in DE 10 2004 046 230 A1 cannot be used whenever it is necessary, for development or cost reasons (small piece numbers, etc), to continue to use the previously used type of sensor in a changed installation situation.

### SUMMARY

It is therefore an object of the invention to provide an improved approach with which disadvantages of conventional techniques can be avoided for fastening a wear sensor to a brake lever having an integrated adjustment function of a vehicle brake. It is the object of the invention in particular to provide the possibility of attaching a retrospectively fittable wear sensor to a brake lever (slack adjuster) of a vehicle brake, in particular of a drum brake, even in the case of the different installation situations or construction space situations. The invention is based in particular on the object of a simple and cost-saving configuration of such a possibility.

These objects are achieved by a device with the features of the independent claim.

Advantageous embodiments and uses of the invention are the subject matter of the dependent claims and are explained in more detail in the description below with reference in part to the figures.

The invention comprises the general technical teaching of providing a device for fastening the wear sensor to the brake lever, by means of which device adaptation to different installation situations is made possible, and therefore it is possible to dispense with adapting the sensor or the sensor housing or the lever arm or lever arm housing. A device of this type is also referred to below for short as adapter device, device or sensor holder.

According to a first aspect of the invention, a device is therefore provided for fastening a wear sensor to a brake lever having an integrated adjustment function of a vehicle brake.

The device has a recess for the contactless passage of a brake shaft, said recess having a contour corresponding to the cross section of the brake shaft. The device furthermore has a first fastening point for fastening a first side of the device to a housing portion of the brake lever, and at least one second fastening point for fastening a wear sensor to a second side of the device opposite the first side. The second fastening point is arranged here spaced apart from the first fastening point.

The adapter device therefore serves as an intermediate element which can be attached between the brake lever and the wear sensor. If, for construction space reasons, the wear sensor cannot be attached to the brake lever housing at the mounting point provided for this purpose, the adapter device can instead be fastened at this point, wherein the wear sensor is then attached at the spaced-apart second fastening point. The position of the second fastening point can be selected or provided in such a manner that the wear sensor can be fitted in the available construction space. In this manner, it is possible to dispense with adapting the sensor or the sensor housing or the lever arm or lever arm housing.

It has already been mentioned above that the terms brake lever and slack adjuster are used synonymously in this document. The same applies to the terms brake lever housing and slack adjuster housing. A highlighted use of the invention relates to the embodiment of the vehicle brake as a drum brake, and to the embodiment of the brake shaft as a brake camshaft, furthermore preferably as an S-cam splined shaft.

In order to take up little additional construction space, the device can be designed as a flat component. For example, the device can be formed from a metallic material, in particular in the form of a flat sheet-metal part. Furthermore, those portions of the device which surround the recess can form two flat contact surfaces on opposite sides of the device in order thereby to permit secure contact against the housing of the brake lever and against the housing of the wear sensor.

In order to realize a simple fastening mechanism, the first fastening point and/or the second fastening point can each have a through-hole. The adapter device can then be fastened to the brake lever housing or to the housing of the wear sensor by means of a bolt which engages in the through-hole and can be designed, for example, as a screw or a pressed-in or welded-in pin. In order to permit a plurality of alternative mounting positions, two or more through-holes can also be provided in order to form differently positioned second fastening points.

According to a particularly preferred embodiment, the device and/or at least that part or portion of the device which bounds the recess can be hook-shaped, sickle-shaped or partially annular. According to this embodiment, the recess is therefore not fully bounded by the device. This embodiment is particularly advantageous if the device is attached to the brake lever in such a manner that said device does not lie in the axial force transmission line between brake lever and wear sensor, but rather in a secondary force transmission line which merely restricts the wear sensor in its degree of rotational freedom. This is explained in more detail below.

According to an alternative particularly preferred embodiment, the recess is designed as a circular perforation in the device. This embodiment is particularly advantageous if the device is attached to the brake lever in such a manner that it lies in the axial force transmission line between brake lever and wear sensor, which is likewise explained in more detail below.

In order to design the device according to this alternative embodiment to be more stable at the connecting points, at least one of the connecting points can have a hole reinforcement. In one possible variant here, the hole reinforcement is provided in the form of a fold for forming an at least double-walled connecting point. In a further possible variant here, the hole reinforcement is provided in the form of a perforated disc surrounding the perforation. In a further possible variant, the hole reinforcement is provided in the form of an elongate, preferably bow-shaped reinforcing plate which extends from the first as far as the second connecting point and, at its two end regions, has a respective through-hole which is aligned with the corresponding through-hole in the device.

According to a second aspect of the invention, an arrangement is provided which has a wear sensor, a brake lever having an integrated adjustment function for a drum brake and also a device, which is described in this document, for fastening the wear sensor to the brake lever (adapter device).

The adapter device according to the invention is arranged between the wear sensor and the housing portion of the brake lever. The adapter device is fastened here via the first fastening point to the housing portion of the brake lever and via the second fastening point to the housing of the wear sensor. In this manner, the housing of the wear sensor is secured non-rotatably with respect to the housing portion of the brake lever. The adapter device can be fastened to the housing of the lever arm or to the housing of the wear sensor at the connecting points by means of a bolt which is designed as a screw or a pressed-in or welded-in pin.

The brake lever here can be divided in a manner known per se into an upper lever portion for connecting to the brake cylinder and into a lower housing portion for attaching to the brake camshaft. The upper lever portion is customarily connected to an actuating element, for example a piston rod, of the brake cylinder. In this connection, an adjustment device in the manner of a gearing, for example in the form of a worm gearing, can be accommodated in a manner known per se in the lower housing portion and with which the brake shaft is adjustable in relation to the brake lever about the axis of rotation of the brake shaft in the event of wear of the brake lining.

Furthermore, the adjustment device can comprise a control arrangement which is known per se and transmits a control movement depending on the angular position of the brake lever from a defined reference point, wherein the control arrangement has a control arm with a control ring, wherein the control arm is connected to an axially fixed component, for example a bearing bracket, of the motor vehicle, thus forming the reference point.

According to a preferred embodiment of the arrangement, the adapter device and/or at least that part of the adapter device which bounds the recess is hook-shaped, sickle-shaped or partially annular, as described above for an exemplary embodiment of the adapter device. The adapter device here is arranged between the wear sensor and the housing portion of the brake lever in such a manner that an edge bounding the recess of the adapter device engages around the control ring and rests on the latter. According to this embodiment of the arrangement, the adapter device does not lie in the axial force transmission line between lever arm and wear sensor, but rather in a secondary force transmission line which only limits the wear sensor in its degree of rotational freedom. This embodiment of the arrangement provides the particular advantage that the additional adapter device does not take up any additional axial construction space.

In an advantageous variant of this embodiment here a size of an opening of the recess is smaller than an outside diameter of the control ring. The size of the opening can be defined, for example, by a distance between the end regions of the partially annular edge or contour bounding the recess. As a result, a mounting aid is realized since, in this case, the adapter device which is still pivotable about the first fastening point during the mounting operation cannot inadvertently slip down again from the control ring having the control arm.

In a further advantageous variant of this embodiment here, a thickness of the adapter device is smaller than or equal to a distance between the mutually facing housing portions of the wear sensor and of the brake lever in the mounted, i.e. in the assembled, state of the arrangement in order, in the assembled state, not to achieve static over determination. The thickness of the adapter device is measured in the mounted state in the axial direction, i.e. in the direction of the axis of the brake camshaft.

According to an alternative preferred embodiment of the arrangement, the adapter device is designed according to the above exemplary embodiments in which the recess is designed as a circular perforation in the adapter device. According to this embodiment, the adapter device is arranged offset axially somewhat with respect to the control disc and bears laterally against the latter and lies in the axial force transmission line between the brake lever and the wear sensor. The adapter device can be secured here in the axial direction of the brake shaft by a securing element.

The invention furthermore relates to a motor vehicle, in particular a commercial vehicle, having an adapter device and/or arrangement, as described in this document.

### BRIEF DESCRIPTION OF THE DRAWINGS

Further details and advantages of the invention are described below with reference to the attached drawings, in which:

FIG. 1 shows a perspective exploded illustration of an arrangement according to a first exemplary embodiment of the invention;

FIGS. 2A and 2B show an adapter device according to a first exemplary embodiment of the invention;

FIG. 3 shows a front view of an arrangement in a partially fitted state according to a first exemplary embodiment;

FIG. 4 shows a perspective exploded illustration of an arrangement according to a second exemplary embodiment of the invention;

FIG. 5 shows a front view of the arrangement from FIG. 4;

FIG. 6 shows a section A-A through FIG. 5;

FIGS. 7A and 7B show an adapter device according to a second exemplary embodiment of the invention;

FIGS. 8A and 8B show an adapter device according to a third exemplary embodiment of the invention;

FIG. 9 shows an adapter device according to a fourth exemplary embodiment of the invention; and

FIGS. 10A and 10B show an adapter device according to a fifth exemplary embodiment of the invention.

### DETAILED DESCRIPTION

Identical or functionally equivalent elements are denoted by the same reference signs in all of the figures. The figures relate to variant embodiments which are used in wear-affected drum brakes of heavy commercial vehicles. Said drum brakes can be installed in a manner known per se as what are referred to as S-cam brakes of simplex design.

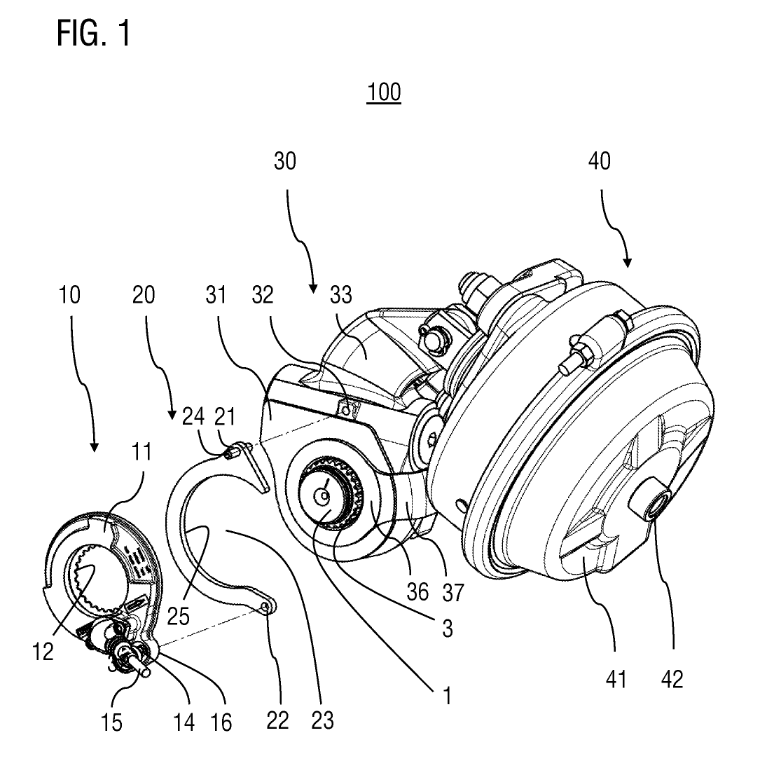

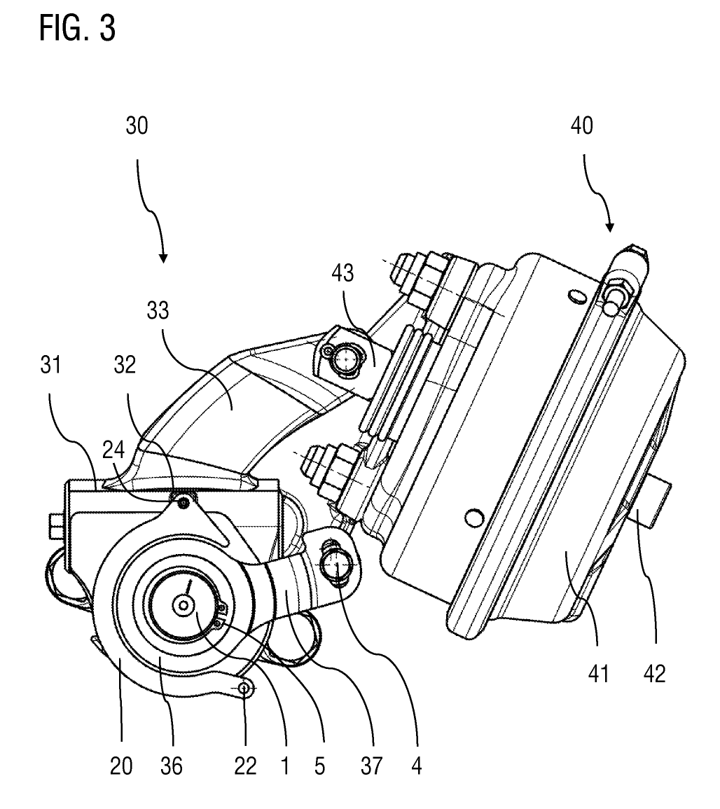

FIG. 1 shows a perspective exploded illustration of an arrangement 100 consisting of a wear sensor 10, a brake lever 30 having an integrated adjustment function for a drum brake (not illustrated), a brake cylinder 40 and a device (adapter device) 20 for fastening the wear sensor 10 to the brake lever 30. FIG. 3 shows a front view of the arrangement from FIG. 1 in a partially fitted state, i.e. still without the wear sensor 10.

The components having the reference signs 10, 30 and 40 are known per se from the prior art and are therefore described only briefly below. It is emphasized that the below-described features of the components 10, 30 and 40 are merely by way of example and also other variant embodiments of the components 10, 30 and 40 can be used with the adapter devices 20, 20a-20d according to the invention.

In a braking operation, the pneumatic cylinder 40 actuates the brake shaft 1 having an S-cam via the brake lever 30 having an integrated adjustment function. The brake shaft 1 is designed as a brake camshaft, in particular as an S-cam splined shaft. The S-cam sitting on the brake shaft 1 is not illustrated in the figures. In FIGS. 1 and 3, said S-cam is located in the axial direction of the brake shaft 1 behind the brake lever 30. As a consequence, said S-cam presses the brake shoes, which are mounted rotatably on one side, of a drum brake against the brake drum and thus produces the desired braking action (in each case not illustrated). The rotation of the brake camshaft 1 in each case causing a braking operation therefore initially takes place by means of the brake cylinder 40, the actuating element 41 of which is connected, for example in the form of a piston rod, to a lever portion 33 of the lever arm (slack adjuster) 30. The brake cylinder 40 is fastened to an axially fixed bearing bracket 4, for example to the axle body. The brake cylinder 40 is pneumatically actuable and, for this purpose, has a pneumatic connection 42 on its housing 41.

The brake lever 30 is divided into an upper lever portion 33 for connecting to the brake cylinder 40 and into a lower housing portion 31 for attaching to the brake camshaft 1. The housing portion 31 serves to accommodate an adjustment device (not visible) which is known per se and is in the manner of a gearing, in particular is in the form of a worm gearing.

By means of the adjustment device, the brake camshaft 1 is adjustable in relation to the brake lever 30 about the axis of rotation of the brake shaft in the event of wear to the brake lining.

The adjustment device comprises a control arrangement which transmits a control movement depending on the angular position of the brake lever 30 from a defined reference point, wherein the control arrangement has a control arm 37 having a control ring 36. The control arm 36 is likewise connected to the bearing bracket 4, thus forming the reference point. The control ring 36 is secured axially with a securing disc 5. As the wear increases, the brake lever 30 adjusts the initial position of the brake camshaft 1, and therefore, at the beginning of each braking operation, there is the same play between brake shoes and brake drum.

In order to be able to continuously determine the state of wear of the brake linings, the wear sensor 10 detects the adjustment which has already taken place. The state of wear of the linings can then be directly derived from the extent of the adjustment which has already taken place. The wear sensor in FIG. 1 comprises a toothed annular plate 12 which meshes with a corresponding toothing 3 of the brake camshaft 1. An annular housing 11 mounted rotatably there around contains the sensor arrangement, for example in the form of Hall sensors, which detect a rotation of the annular plate 12 in relation to the housing 11.

The sensor signals are output by means of a connecting line 15. The housing 11 is intended to be arranged non-rotatably with respect to the housing 31 of the brake lever.

This takes place in the prior art only by means of a pin which is fastened to the brake lever housing 31 at a point provided for this purpose and thus secures the sensor housing 11 against rotation. In FIG. 1, this point on the housing 31 of the brake lever 30 is identified by the reference sign 32. If the sensor 10 were fastened directly to the brake lever 10 in a conventional manner and not, according to the invention, to the brake lever 10 by means of the device 20, the sensor would have to be rotated and oriented about the brake camshaft 1 in such a manner that the through-hole 16 on the sensor housing 11 lies directly opposite the fastening point 32 of the brake lever housing 31 and can be fastened there to the pin or bolt 14. If, however, the construction space does not suffice in the region of the connecting point 32 to the brake lever housing 31 in order, for example, to accommodate the holder for the connecting line 15, the sensor 10 could not be fitted there.

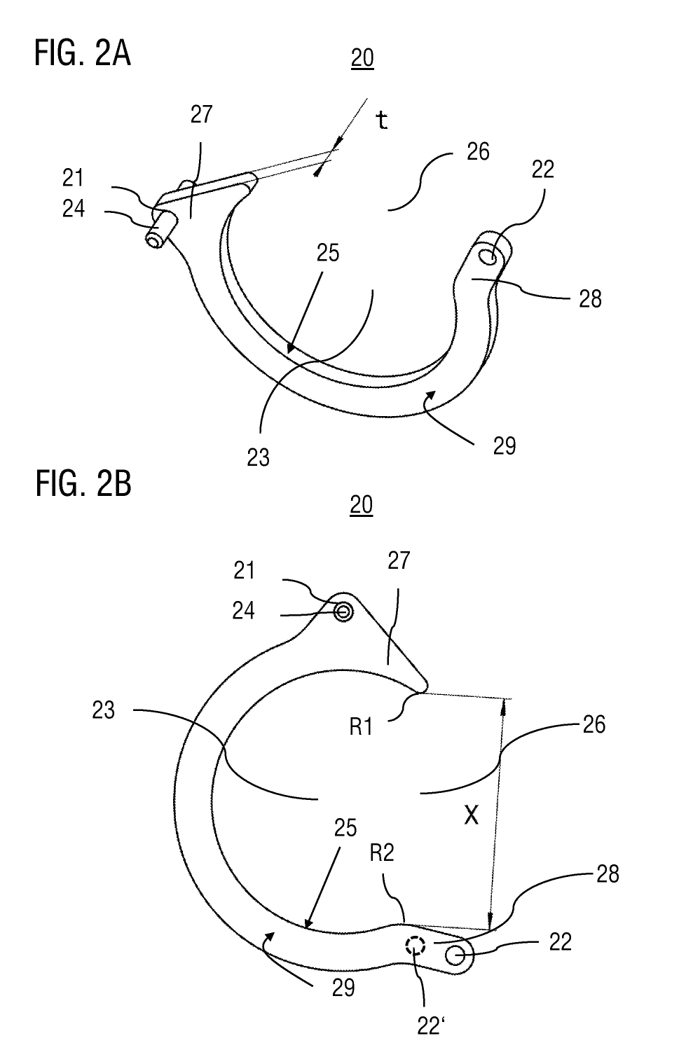

According to the invention, the adapter device 20 in the form of an intermediate element is therefore proposed. FIGS. 2A and 2B show detailed views of the adapter device. The sensor 10 can be fastened to the brake lever housing 31 in other rotational positions by means of the adapter device 20. The adapter device 20 therefore serves as a sensor holder via which the sensor 10 is fastened to the brake lever housing 31.

In the present case, the adapter device 20 is designed as a flat component in the form of a sheet-metal part. The sheet-metal part is substantially hook-shaped or sickle-shaped and has a recess 23 for the contactless passage of the brake camshaft 1, which recess has a contour corresponding to the cross section of the brake camshaft 1, and therefore the adapter device can be arranged substantially coaxially with respect to said brake camshaft, but is not in contact therewith. The edge 25 bounding the recess 23 is partially annular. The adapter device therefore has an opening 26 in the radial direction on one side. Those portions of the adapter device 20 which surround the recess 23 form two flat contact surfaces 29 in the axial direction on opposite sides of the adapter device 20, of which contact surfaces one bears against the brake lever housing 31 and the other bears against the sensor housing 11 in the fitted state of the arrangement.

On a first end region 27, the adapter device 20 has an integrally formed lug with a through-hole 21. The through-hole serves to receive a fastening bolt 24 via which the adapter device 20 is fastened to the brake lever housing 31 at the predetermined point 32.

On a second end region 28 which is arranged opposite the first end region, the adapter device 20 has a web which slightly bends away outwards and which likewise has a through-hole 22. The fastening sensor is fastened to this point by means of a bolt 14 which engages in the through-hole 16 in the sensor housing 11. By means of the adapter device 20, the sensor 10 can therefore be installed rotated virtually by 180 with respect to the originally provided mounting position. As illustrated in FIG. 2B, a second through-hole 22′ can alternatively also be provided in the end region 28 in order to provide an alternative mounting position for the sensor housing 11.

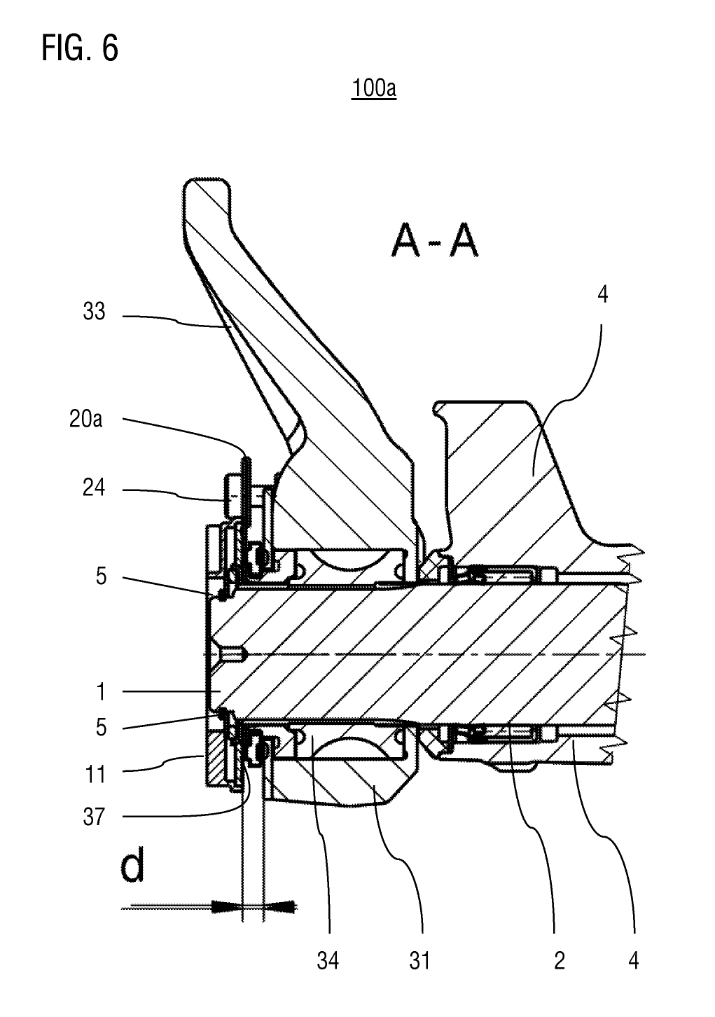

FIG. 3 shows a front view of the arrangement 100 in a partially fitted state, i.e. after the adapter device 20 is fastened to the brake lever housing 31 and before the sensor 10 is attached. The adapter device 20 is attached to the brake lever housing 31 in such a manner that it does not lie in the axial force transmission line between lever arm 30 and wear sensor 10, but rather in a secondary force transmission line which merely restricts the wear sensor 10 in its degree of rotational freedom. Use is made here of the fact that a gap, the thickness d of which is illustrated in FIG. 6, forms between sensor housing 10 and the housing 31 of the brake lever 30. According to the variants shown in FIGS. 1 and 3, this construction space is used for arranging the adapter device 20, as a result of which no additional construction space is required by the adapter device 20 in the axial direction. Furthermore, the adapter device 20 is thereby secured axially.

For this purpose, the edge 25 which bounds the recess 23 or defines the contour thereof engages around the control ring 36 and therefore rests thereon. Consequently, the thickness t of the adapter device 20, which thickness is illustrated in FIG. 2A, is smaller than or equal to the distance d, which is illustrated in FIG. 6, between the mutually facing housing portions of the wear sensor 10 and of the brake lever 30 in order not to achieve any static over determination in the assembled state. The size x illustrated in FIG. 2B, of the radial opening 26 of the recess 23 is smaller than an outside diameter D of the control ring 36 in order to avoid the adapter ring slipping down off the control disc 36 during the mounting operation. The size x of the radial opening 26 corresponds here to the distance between the mutually opposite border points R1, R2 which define the border points of the opening 26.

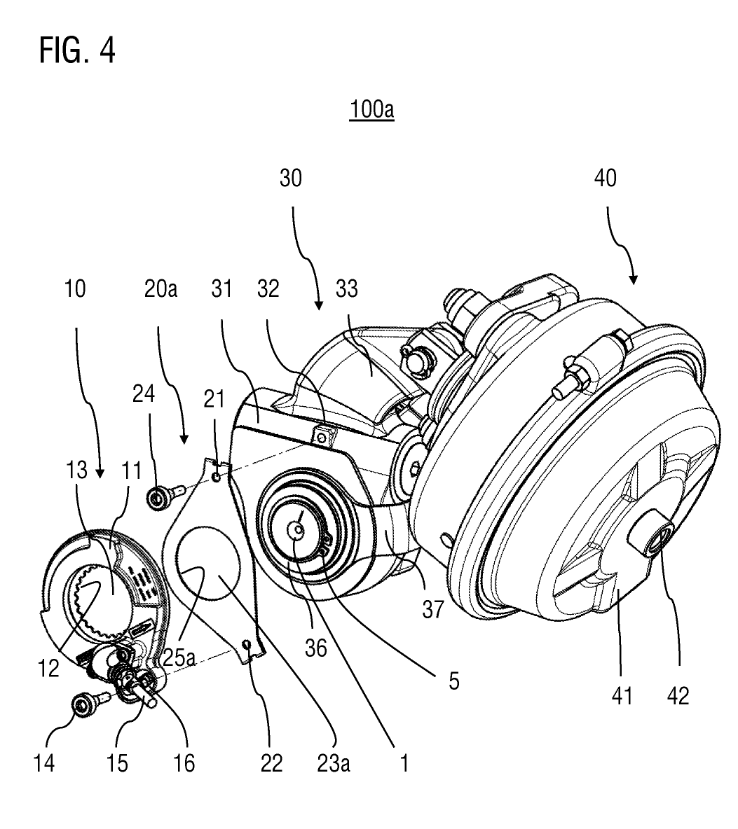

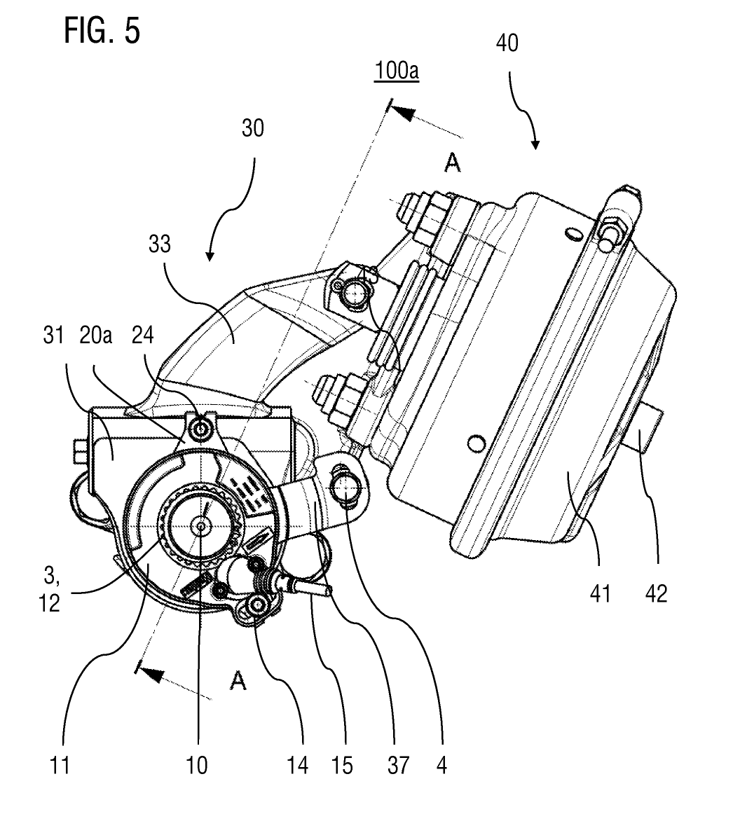

FIG. 4 shows a perspective exploded illustration of an arrangement according to a second exemplary embodiment of the invention, and FIG. 5 shows a front view of the arrangement from FIG. 4. Components having the same reference signs correspond here to the components of FIG. 1 and are not described separately.

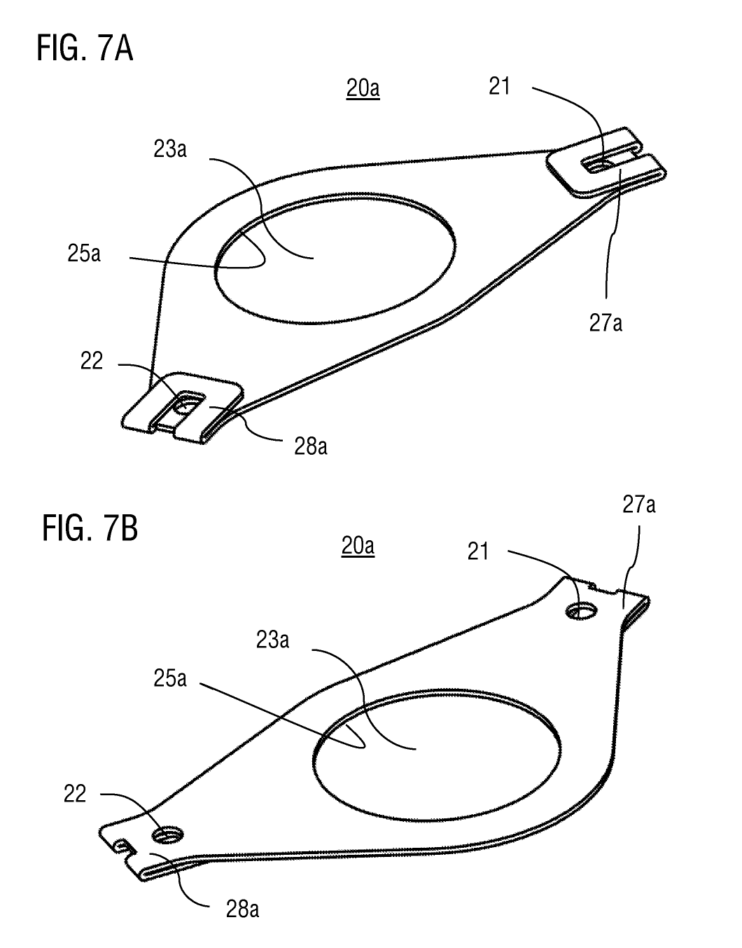

A particular feature of this variant embodiment consists in the fact that the adapter device 20a is not of hook-shaped design, but rather in that the recess 23 is designed as a circular perforation in the device 20a. An example is illustrated in FIGS. 7A and 7B which show the front side and the rear side of the adapter device 20a.

A further particular feature of this variant embodiment consists in the fact that the adapter device 20a is introduced into the axial force transmission line between the housing portion 31 of the brake lever 30 and the wear sensor 10, i.e. the adapter device 20a is arranged offset in the axial direction with respect to the control disc 36 and is secured in the axial direction of the brake camshaft 1 by a securing disc 5. For construction space reasons, the thickness or the wall thickness of the adapter device 20a should therefore be as small as possible. In order to reinforce the adapter device at the connecting points at which the adapter device 20a is fastened to the brake lever housing 30a or to the sensor housing 11, a respective hole reinforcement can be provided there. This can be seen in the sectional illustration of FIG. 6 which shows that the wall thickness of the adapter device 20a is thicker at the connecting point to the brake lever housing 31, at which the fastening takes place by means of the bolt 24, than in the central region in the vicinity of the brake camshaft 1. FIG. 6 furthermore shows the bearing 2 with the brake camshaft 1 and a part 34 of the worm gearing for adjusting the brake lever.

As shown in FIGS. 7A and 7B, the hole reinforcement at the connecting points 21, 22 can be provided in the form of a fold 27a, 27b in order to form a double-walled connecting point.

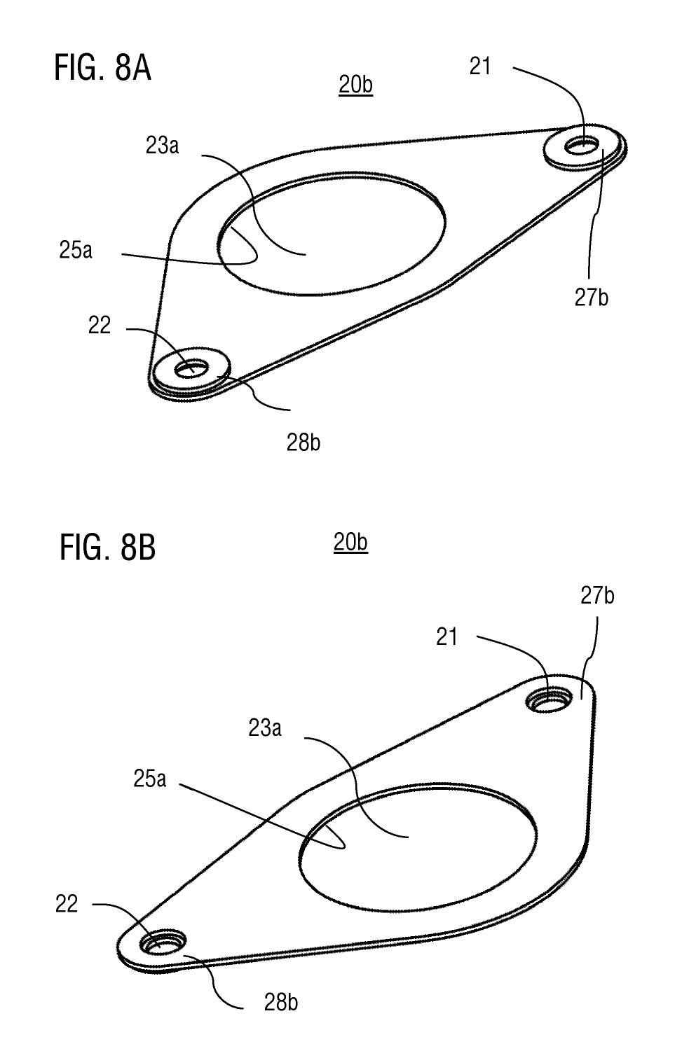

A further variant 20b of the adapter device is shown in FIGS. 8A and 8B, wherein the hole reinforcement is provided in the form of a perforated disc 27b, 28b respectively surrounding the through-holes 21, 22.

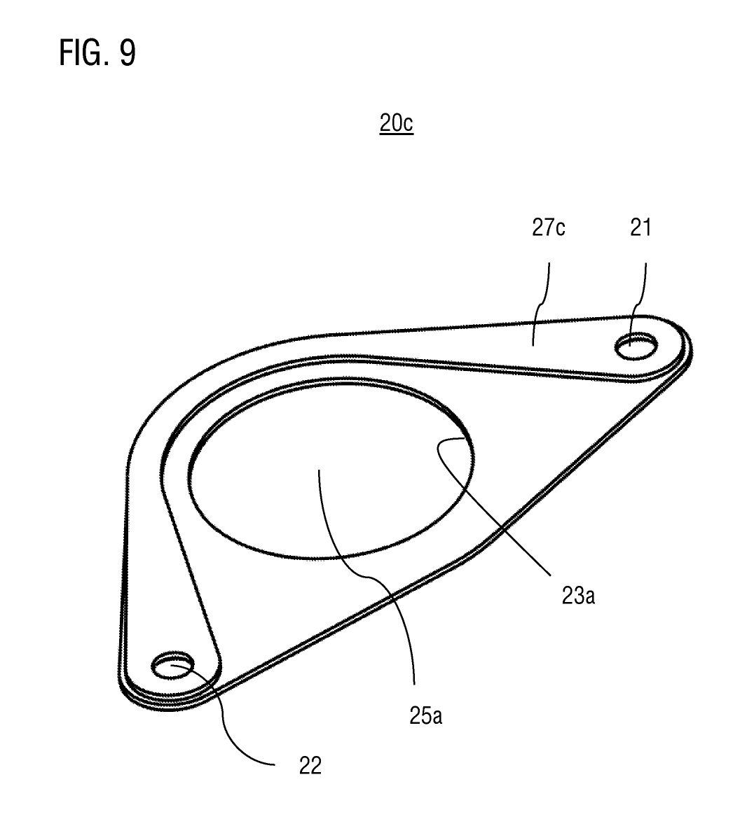

A further variant 20c of the adapter device 20c is shown in FIG. 9, wherein the hole reinforcement is provided in the form of an elongate, preferably bow-shaped reinforcing plate 27c which extends from the first as far as the second connecting point and, at its two end regions, has a respective through-hole which is aligned with the corresponding through-hole 21,22 in the adapter device 20c.

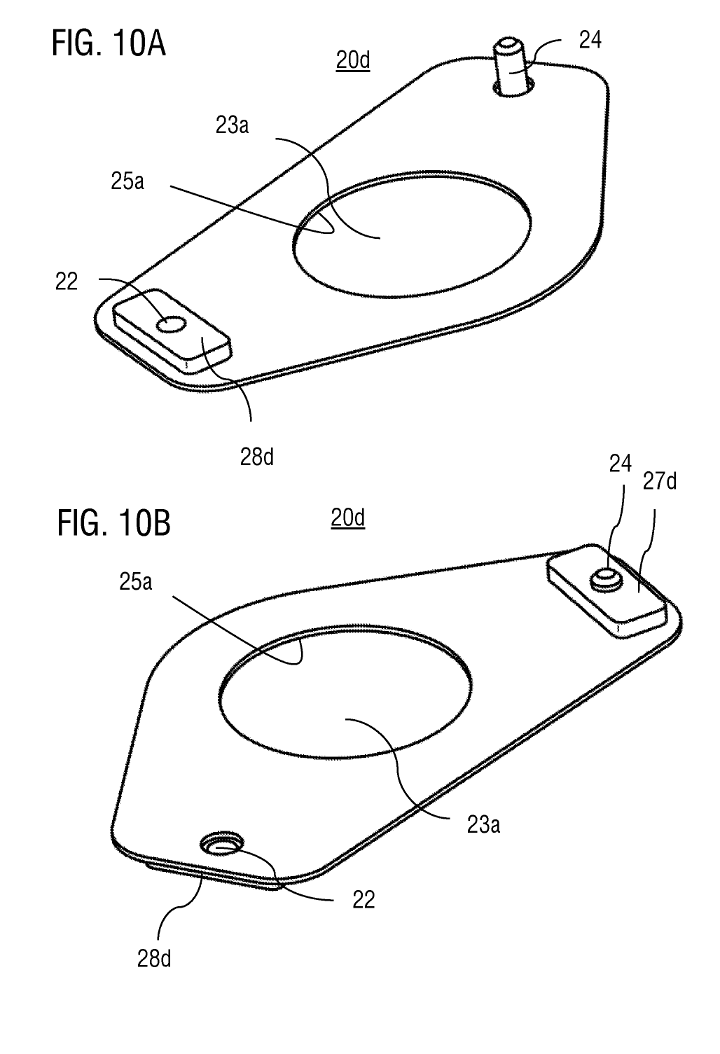

A further variant 20d of the adapter device is shown in FIGS. 10A and 10B, wherein the hole reinforcement is provided in the form of a perforated plate 27d surrounding the perforations 21, 22.

Although the invention has been described with reference to certain exemplary embodiments, it is apparent to a person skilled in the art that various amendments can be made and equivalents can be used as a replacement without departing from the scope of the invention. In addition, a multiplicity of modifications can be implemented without departing from the associated scope. Consequently, the invention is not intended to be limited to the disclosed exemplary embodiments, but rather is intended to include all of the exemplary embodiments which fall within the scope of the appended patent claims. In particular, the invention also claims protection for the subject matter and the features of the dependent claims independently of the claims referred to.

1. A device for fastening a wear sensor to a brake lever including an integrated adjustment function of a vehicle brake, comprising:
a recess for the contactless passage of a brake shaft;
a first fastening point for fastening a first side of the device to a housing portion of the brake lever;
at least one second fastening point for fastening a wear sensor to a second side of the device opposite the first side, wherein the second fastening point is arranged spaced apart from the first fastening point.

2. The device according to claim 1, further comprising a through-hole formed in the first fastening point and the second fastening point.

3. The device according to claim 1, wherein the device is designed as a flat component, in particular as a sheet-metal part.

4. The device according to claim 1, further comprising two flat contact surfaces on opposite sides of the device that surround the recess.

1. The device according to claim 1, wherein at least that part of the device which bounds the recess is hook-shaped, sickle-shaped or partially annular.

6. The device according to claim 1, wherein the recess is designed as a circular perforation in the device.

7. The device according to claim 6, further comprising at least one connecting point having a hole reinforcement.

8. The device according to claim 7, wherein the hole reinforcement
(a) is provided in the form of a fold for forming an at least double-walled connecting point; and/or
(b) is provided in the form of a perforated disc surrounding the perforation, or in the form of a perforated plate; or
(c) is provided in the form of an elongate, preferably bow-shaped reinforcing plate which extends from the first as far as the second connecting point and, at its two end regions, has a through-hole which is aligned with the corresponding through-hole in the device.

9. An arrangement comprising:
a brake lever having an integrated adjustment function for a drum brake;
a wear sensor; and
a device for fastening the wear sensor to the brake lever, the device including:
a recess for the contactless passage of the brake shaft;
a first fastening point for fastening a first side of the device to a housing portion of the brake lever;
at least one second fastening point for fastening the wear sensor to a second side of the device opposite the first side, wherein the second fastening point is arranged spaced apart from the first fastening point.

9. arrangement according to claim 9, wherein
(a) the brake lever includes a lever portion connected to a brake cylinder and a housing portion attached to a brake shaft.

11. The arrangement according to claim 10, wherein the brake shaft is an S-cam spline shaft.

12. The arrangement according to claim 11, further comprising an adjustment device accommodated in the housing portion for adjusting the brake shaft in relation to the brake lever about the axis of rotation of the brake shaft in the event of wear of a brake lining.

13. The arrangement according to claim 12, wherein the adjustment device is a worm gear.

14. The arrangement of claim 11, wherein the device is arranged between the wear sensor and the housing portion of the brake lever and is fastened at the first fastening point to the housing portion of the brake lever and at the second fastening point to a housing of the wear sensor and thereby secures the housing of the wear sensor non-rotatably with respect to the housing portion of the brake lever.

15. The arrangement according to claim 11, further comprising:
(a) two flat contact surfaces on opposite sides of the device that surround the recess, wherein the adjustment device includes a control arrangement which transmits a control movement depending on the angular position of the brake lever, wherein the control arrangement has a control arm with a control ring, and the control arm is connected to a bearing bracket; and wherein the device is arranged between wear sensor and the housing portion of the brake lever such that an edge bounding the recess of the device engages around the control ring.

16. The arrangement according to claim 15, wherein a size of an opening which is formed by a distance between the end regions of a partially annular edge bounding the recess is smaller than an outside diameter of the control ring.

17. The arrangement according to claim 14, wherein a thickness of the device is smaller than a distance between the housing portion of the wear sensor and the housing portion of the brake lever.

18. The arrangement according to claim 9, wherein the device is arranged in an axial force transmission line between the housing portion of the brake lever and the wear sensor and is secured in the axial direction of the brake shaft by a securing element.

19. The arrangement according to claims 9, wherein the device is fastened at connecting points to the housing of the lever arm or to the housing of the wear sensor by a bolt which is designed as a screw or as a pressed-in or welded-in pin.

20. A motor vehicle comprising:
a brake lever having an integrated adjustment function for a drum brake;
a wear sensor; and
a device for fastening the wear sensor to the brake lever, the device including:
a recess for the contactless passage of the brake shaft;
a first fastening point for fastening a first side of the device to a housing portion of the brake lever;
at least one second fastening point for fastening the wear sensor to a second side of the device opposite the first side, wherein the second fastening point is arranged spaced apart from the first fastening point.
